(19) United States
(12) Patent Application Publication
(10) Pub. No.: US 2009/0197014 A1
(43) Pub. Date: Aug. 6, 2009

(54) Apparatus and method for coating diamond on work pieces via hot filament chemical vapor deposition

(75) Inventors: Jin-Yu Wu, Longtan Shiang (TW); Chun-Han Wang, Taipei City (TW); Ding-Guey Tsai, Taoyuan City (TW); Ming-Ruesy Tsai, Hsinchu City (TW); Chi-Fong Ai, Longtan Shiang (TW)

Correspondence Address: TROXELL LAW OFFICE PLLC, SUITE 1404, 5205 LEESBURG PIKE, FALLS CHURCH, VA, 22041, US

(73) Assignee: ATOMIC ENERGY COUNCIL - INSTITUTE OF NUCLEAR ENERGY RESEARCH, Taoyuan (TW)

(21) Appl. No.: 12/068,249

(22) Filed: Feb. 4, 2008

(51) Int. Cl. H05H 1/24; B05C 11/00

(52) U.S. Cl. 427/569; 118/708

(57) ABSTRACT

There is a disclosed apparatus for coating diamond on work pieces via hot filament chemical vapor deposition. The apparatus includes a chamber, a pump for pumping air from the chamber, a pressure controller for con trolling the pressure in the chamber, a grid disposed in the chamber, a grid-bias power supply for providing a positive bias to the grid, a holder for carrying the work pieces, a holder-bias power supply for providing a negative bias to the holder, filaments provided between the grid and the carrier, a filament power supply for energizing the filaments to heat up, a programmable temperature controller for controlling the temperature in the chamber and a pipe for transferring reaction gas into the chamber.

### FIELD OF THE INVENTION

The present invention relates to an apparatus and method for coating diamond on work pieces via hot filament chemical vapor deposition.

### DESCRIPTION OF THE RELATED ARTS

Hot filament chemical vapor deposition (“HFCVD”) is often used to coat diamond on a tool such as micro-drill or micro-router. In the HFCVD, a hot filament is used as a heating source for gases dissociation. On contacting the hot filament at 1800 to 2500 degrees Celsius, under tens of torrs, hydrogen or hydrocarbon gas such as methane, acetylene and acetic acid is dissociated into radicals such as hydrogen atoms and methyl. The radicals are chemically active. When the concentration of the methyl and hydrogen (CH₄/H₂) is about 0.5% to 6%, many active hydrogen atoms form carbon-hydrogen bonds on the diamond film to prevent graphite bonds (carbon-carbon bonds: C=C) from forming on the diamond film. Such graphite bonds would affect the quality of the diamond film. Thus, the diamond film is protected. Moreover, during the deposition of the carbon atoms, the hydrogen atoms react with hydrogen of the carbon-hydrogen bonds and form hydrogen gas so that the carbon atoms on the surface would become dangling bonds. When the methyl comes near, sp3 complex orbits will occur. If the temperature is retained at 800 to 1250 degrees Celsius on the surface of the tool, the diamond film will be formed smoothly.

However, because the diamond bonds are strong, when the carbon film is grown on the tool, the adhesion of the carbon film to the tool is weak. Moreover, because the hardness of the diamond film is high, and the thermal expansion coefficient is low, when the temperature returns to the room temperature from the high temperature for growing the diamond film on the tool, there will be intensive stress in the diamond film. When the diamond film is thicker the adhesion is worse. Therefore, the diamond film could easily be peeled from the tool.

According to U.S. Pat. No. 5,833,753, there is disclosed an array of hot filaments for growing diamond of a large area on a tool. It is however difficult to uniformly deposit diamond on a rough surface.

According to EPO Patent No. 254312 and U.S. Pat. No. 6,200,652, biases are provided between grid, a filament and a base to generate a plasma above the base to help diamond grow on the tool surface. It is however difficult to uniformly deposit diamond on a rough surface. Moreover, these techniques are not designed for metallic tools. The bonding of the diamond film to the tool cannot tolerate high-speed rotation although the double biases independently applied on filament and substrate is beneficial for the nucleation on a silicon substrate or a quartz tool. Therefore, the diamond film could easily be peeled from the tool.

Industrial micro-routers and micro-drills of diameter 3 mm to 0.1 mm are made of tungsten carbide with a micro-hardness of 2500 HV suitable for processing printed circuit boards. However, it is difficult to form diamond nuclides on such tool so that the number of the diamond nuclides is low and that the bonding of the coated diamond film to such tool is weak and the diamond film could easily be peeled from tool surface. Plasma could be used to help the forming of the diamond nuclides to enhance the bonding of the diamond nuclides to such tools. However, the particles in such plasma are highly energetic and could twist the diamond bonds or form graphite bonds by hitting the tool. Therefore, the diamond bonds would be stressed or replaced with the graphite bonds. That is, the bonding of the diamond film to such tools would be weak. Coated with diamond film, the life time of routers of diameter more than 3 mm could be extended for several times. However, a router, diameter smaller than 3 mm, could easily be broken on contacting a work piece in high speed machining. The cutting rate and tribology are obviously important as w ell as the bonding of the diamond films to the tools.

The present invention is therefore intended to obviate or at least alleviate the problems encountered in prior art.

### SUMMARY OF THE INVENTION

The primary objective of the present invention is to provide an apparatus for firmly coated diamond on work pieces via hot filament chemical vapor deposition.

To achieve the foregoing objective, the apparatus includes a chamber. The chamber is water-cooled and the pressure is controllable therein. A valve is provided on the chamber. A pump is in connection with the valve for pumping air from the chamber. A pressure gauge is inserted in the chamber. A pressure regulator is connected to the pump valve on one side and connected to the pressure gauge on the other side for controlling the valve based on the reading of the pressure gauge. A grid includes vents defined therein. The grid is mechanically disposed in but electrically isolated from the chamber. A grid-bias power supply applies a bias to the grid for generating plasma. A workpiece holder includes rows of vents defined therein and rows of apertures defined therein for holding the work pieces. The rows of vents and the rows of apertures are arranged alternately. The holder is disposed in but isolated from the chamber. A holder-bias power supply provides a bias to the holder for generating the plasma. Stationary holding elements are mechanically disposed in but electrically isolated from the chamber. Movable holding elements are disposed in the chamber. Filaments are arranged in two tiers between the grid and the r holder. Each of the tiers includes rows. Each row of each tier of the filaments is supported by and between a related stationary holding element and a related movable holding element. A tension controller includes an end mechanically connected to but electrically isolated from a related movable holding element and another end connected to the chamber so that each tension controller is operable to horizontally move the related row of each tier of the filaments. A filament power supply energizes the filaments to heat up. A programmable temperature controller controls the filament power supply to make the filaments work at different temperatures in different periods. A piping extends in the chamber and includes tapering vents for spraying reaction gas upwards so that the reaction gas uniformly falls and is finally pumped out of the chamber by the pump. Different temperatures of workpiece can be controlled in nucleation and growth process of diamond film for enhancing adhesion and prolonging their life time.

Other objectives, advantages and features of the present invention will become apparent from the following description referring to the attached drawings.

### BRIEF DESCRIPTION OF THE DRAWINGS

The present invention will be described via detailed illustration of the preferred embodiment referring to the drawings.

FIG. 1 is a perspective view of an apparatus for coating diamond on work pieces via hot filament chemical vapor deposition according to the preferred embodiment of the present invention.

FIG. 2 is a perspective view of a grid used in the apparatus of FIG. 1.

FIG. 3 is a perspective view of a work piece holder used in the apparatus of FIG. 1.

FIG. 4 is a flow chart of a process used in the apparatus shown in FIG. 1.

FIG. 5 is a chart of deposition time vs. temperature.

### DETAILED DESCRIPTION OF EMBODIMENT

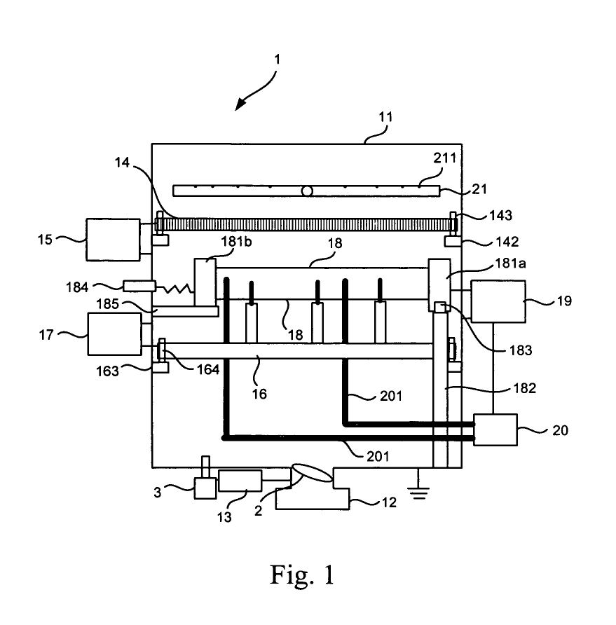

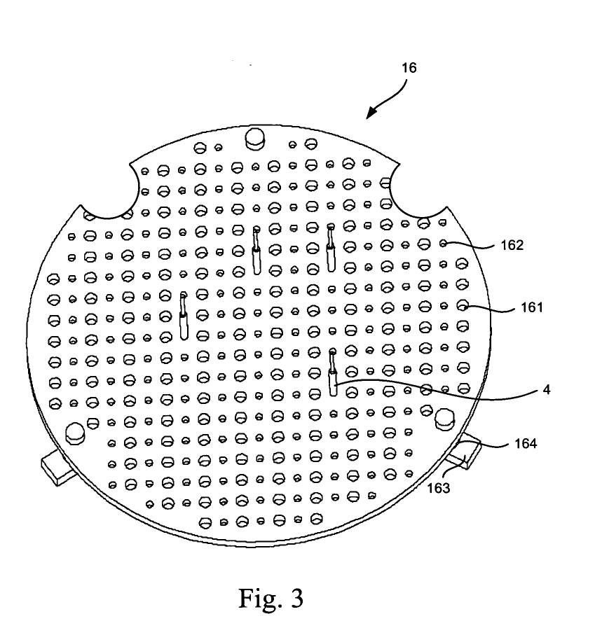

Referring to FIG. 1, it shows an apparatus 1 for coating diamond on workpieces 4 (FIG. 3) via hot filament chemical vapor deposition according to the preferred embodiment of the present invention. The apparatus 1 includes a chamber 11, a pump 12, a pressure controller 13, a grid 14, a grid-bias power supply 15, a holder 16, a holder-bias power supply 17, filaments 18, a filament power supply 19, a programmable temperature controller 20 and a piping 21. The work pieces 4 may be micro-tools for high-speed operation for example. With the apparatus 1, diamond can firmly be coated on the work pieces 4.

The chamber 11 is water-cooled. The pressure is controllable in the chamber 11. The chamber 11 is connected to the pump 12 via a pipe. The pump 12 pumps gas out of the chamber 11 so that the pressure is reduced to several torrs in the chamber 11.

The pressure controller 13 is connected to a pressure gauge 3 on one side and connected to a valve 2 on the other side. The valve 2 is provided on the chamber 11 so that gas travels from the chamber 11 to the valve 2. The pressure gauge 3 is partially inserted in the vacuum 11. Based on the reading of the pressure gauge 3, the pressure controller 13 can adjust the valve 2 to control chamber pressure.

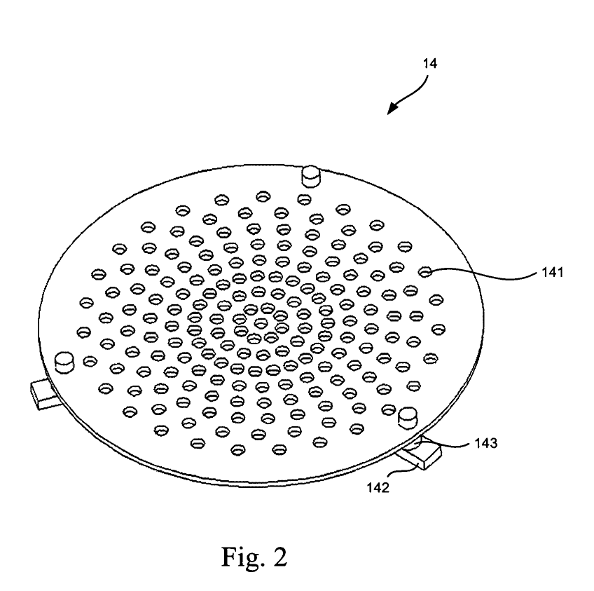

Referring to FIG. 2, the grid 14 is a metal plate with vents 141 defined therein. The grid 14 is supported on mounts 142 that are secured to an internal side of the chamber 11. An isolating pin 143 includes an end attached to each of the mounts 142 and another end inserted in the grid 14, thus isolating the grid 14 from the chamber 11. The diameter of the vents 141 is 0.3 to 5 mm. The vents 141 are located so that gas can uniformly be distributed through them. The vents 141 are closer to one another in the middle of the grid than near the periphery of the grid.

The grid-bias power supply 15 is connected to the grid 14. The grid-bias power supply 15 provides a positive bias to the grid 14 to generate plasma. The positive bias is tens to hundreds of volts. The grid-bias power supply 15 may provide a direct current or direct current pulses.

Referring to FIG. 3, the holder 16 is a metal plate with rows of vents 161 defined therein and rows of apertures 162 defined therein. The rows of vents 161 and the rows of apertures 162 are alternately arranged. The holder 16 may be made of grains of a diameter of several to tens of micrometers. The diameter of the vents 161 is 0.3 to 5 mm. The diameter of the apertures 162 is 1 to 20 mm. The holder 16 is mounted on mounts 163 that are secured to an internal side of the chamber 11. At least one isolating sleeve 164 is provided between each of the mounts 163 and the holder 16, thus isolating the holder 16 from the chamber 11. The height of the holder 16 can be adjusted by adjusting the number of isolating sleeves 164 between each of the mounts 163 and the holder 16.

The holder-bias power supply 17 is connected to the holder 16. The holder-bias power supply 17 provides a negative bias to the holder 16 to generate plasma. The negative bias is negative tens of volts to lower than negative one hundred volts. The holder-bias power supply 17 may provide a direct current or pulsed direct current.

The filaments 18 may be made of tungsten, molybdenum, tantalum or any alloy of these metals so that the filaments 18 can be used to coat diamond on the work pieces 4 without having to be carbonized beforehand. The filaments 18 are arranged in two tiers each including rows. The distance between any two adjacent rows of the filaments 18 is equal to the distance between any two adjacent rows of the apertures 162. The distance is 1 to 2 cm. The tiers are located between the grid 14 and the holder 16. The distance between the upper tier and the grid 14 is 0.5 to 2 cm. The distance between the lower tier and the work pieces 4 is 0.3 to 1 cm. The distances are determined based on the sizes of the work pieces 4.

Each row of the upper tier of the filaments 18 and a related row of the lower tier of the filaments 18 are supported by and between two holding elements 181a and 181b. The holding elements 181a and 182b are made of molybdenum or any other metal of a high melting point. Each holding element 181a is up ported on a post 182 that is secured to the internal side of the chamber 11. The posts 182 may be replaced with mounts like the mounts 142. An isolating cap 183 is provided between each holding element 181a and a related post 182, thus isolating the filaments 18 from the chamber 11. Each holding element 181b is connected to a tension controller 184 attached to the chamber 11. The tension controllers 184 are operable to move the filaments 18 horizontally. There are grooves 185 each for receiving and guiding a related holding element 181b. The tension controller 184 may be embodied as a weight, a spring or a hydraulic cylinder.

The filament power supply 19 is connected to the filaments 18. The filament power supply 19 energizes the filaments 18 to heat up to 1800 to 2500 degrees Celsius.

The programmable temperature controller 20 is used together with at least one thermometer 201. The thermometer 201 is inserted through a selected one of the apertures 162. The thermometer 201 measures the temperature of an adjacent work piece 4 and accordingly sends a signal to the programmable temperature controller 20. The thermometer 201 may be an infrared thermometer. Based on the signal, the programmable temperature controller 20 sends a signal of 0 to 10 V or 4 to 20 mA to the filament power supply 19. A program controls the filament power supply 19 to heat the filaments 18 and then the work pieces 4 to different temperatures in different periods. The programmable temperature controller 20 may be a programmable logic controller or a computer so that it is not affected by plasma bombardment.

Preferably, many thermometers 201 are connected to the programmable temperature controller 20. Each thermometer 201 is located near a related work piece 4. The programmable temperature controller 20 may be used for programmable control over temperature differentials. Hence, if a filament 18 with a thermocouple nearby is broken, it can be replaced with at least one adjacent filament 18 with the other thermocouple nearby.

The piping 21 includes a trunk and branches extended from the trunk. Each of the branches includes vents 211 defined therein. Each of the vents 211 tapers while extending from the axis of the related branch. The vents 211 spray reaction gas upwards. Then, the reaction gas uniformly falls. Finally, the pump 12 pumps the reaction gas out of the chamber 11. The piping 21 may be T-shaped, cruciform or multi-directional for example. The reaction gas includes hydrogen, methane, acetylene, ethane, benzene and alcohol for example.

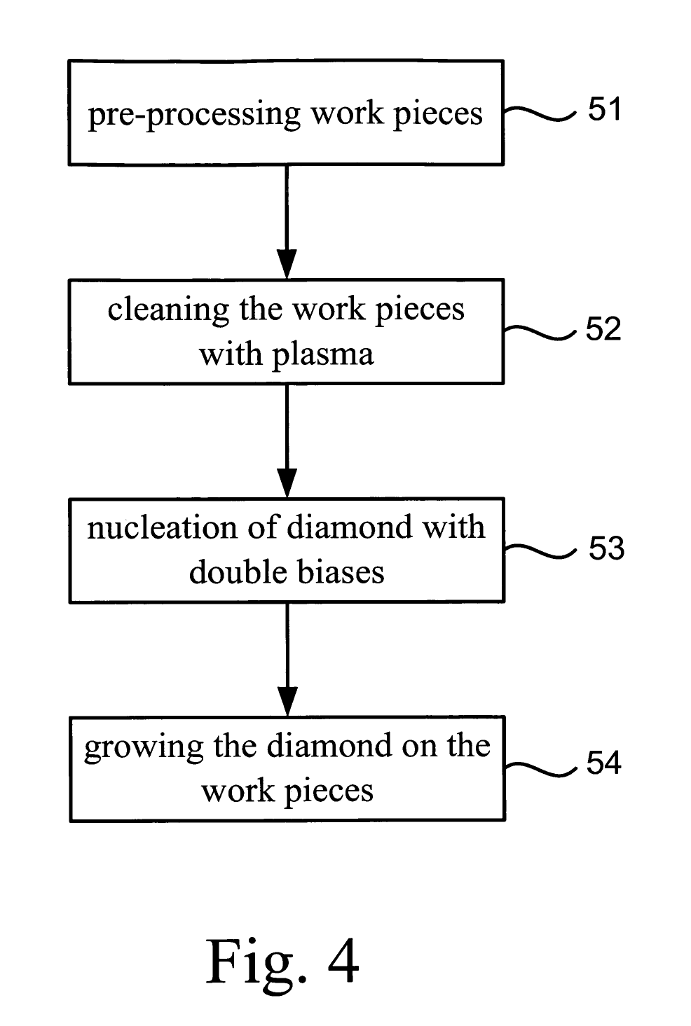

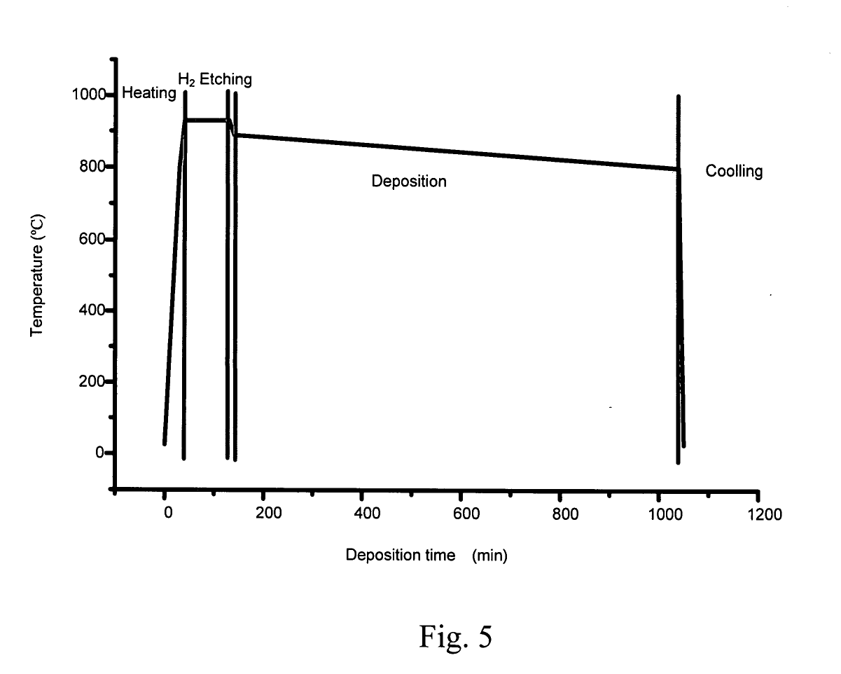

Referring to FIGS. 4 and 5, the operation of the apparatus 1 will be described. At 51, there is provided first chemical solution including potassium ferricyanide, potassium hydroxide and de-ionized water. The work pieces 4 are submerged in the chemical liquid for 20 minutes so that the surface of work pieces 4 are chemically etched and become rough. Then, there is provided second chemical liquid including 30% of sulfoxylic acid and 70% of hydrochloride. The work pieces 4 are submerged in the second chemical liquid for 20 seconds so that cobalt is removed from the work pieces 4. Thus, no cobalt absorbs any diamond. The attachment of the diamond to the work pieces 4 will not be affected. Then, there is provided third chemical solution including diamond grains and de-ionized water. The diamond grains are smaller than 1 micrometer in diameter. The work pieces 4 are washed as they are submerged in the third chemical solution and subjected to ultrasonic oscillation for 20 minutes. Finally, the work pieces 4 are removed from the third chemical solution and dried.

At 52, the workpieces 4 are inserted in the apertures 162 of the carrier 16 of the apparatus 1. The pump 12 reduces the pressure to a desired value in the chamber 11. From the vents 211 of the piping 21, gas that contains 2% of methane/hydrogen is introduced into the chamber 11 so that the pressure is 20 torrs in the chamber 11.

A first stage of the coating process lasts for 30 minutes under the control of the programmable temperature controller 20. In the first stage of the coating process, the filament power supply 19 energizes the filaments 18 to heat the workpieces 4 so that the temperature of the work pieces 4 is raised to 750 to 800 degrees Celsius.

In a second stage of the coating process, a positive bias of 100 V is exerted on the grid 14 while a negative bias of −60 V is exerted on the holder 16. The work pieces 4 are cleaned in this environment of hydrogen plasma for 10 to 30 minutes so that impurity is removed from the work pieces 4, i.e., the work pieces 4 are cleaned. At the same time, the temperature of the work pieces 4 is increased to 900 to 980 degrees Celsius from 750 to 800 degrees Celsius.

At 53, in a third stage of the coating process, the grid 14 is provided with a positive bias of 30 to 200 V while the holder 16 is provided with a negative bias of −30 to −150 V. The temperature of the work pieces 4 is retained at 900 to 980 degrees Celsius. Into the chamber 11 is introduced other gas including 0.5% to 4% of methane/hydrogen so that the pressure reaches 20 torrs in the chamber. With the power supplies 15 and 17, discharge occurs between the grid 14 and the filaments 18, which are grounded, to generate plasma. When the filaments 18 emit electrons to the grid 14 at high temperature, the electrons partially ionized hydrogen, methane and these radicals. These ions are attracted by work pieces and impinged on then which are provided with the negative bias. These ions help and enhance the production of diamond includes on the work pieces 4. After 3 minutes to 3 hours, the power supplies 15 and 17 are turned off, the temperature of the work pieces 4 drops to 800 to 880 degrees Celsius. The methane may be replaced with acetylene, ethane, benzene and/or alcohol.

At 54, in a fourth stage of the coating process, the grid 14 is grounded while the work pieces 4 are grounded or floating. The temperature of the work pieces 4 drops gradually to 780 degrees Celsius from 800 to 880 degrees Celsius. Gas including 0.5% to 4% of methane is introduced into the chamber 11 so that the pressure becomes 10 to 50 torrs in the chamber 11. By reducing the temperature steadily, i.e., in a gradient, re-composition occurs and deposit diamond of 1 to 10 micrometers on the work pieces 4. The time required for growing the diamond film is 5 to 20 hours. After the growth the supply of the methane is stopped. In tens of minutes, the temperature of the work pieces 4 is reduced to the room temperature so that the work pieces 4 can be removed from the apparatus. The methane may be rep laced with acetylene, ethane, benzene and/or alcohol.

The temperature of the work pieces 4 can be retained at 950 to 1000 degrees Celsius for a period of time for the diamond film growing and reduced to and retained at 780 to 830 degrees Celsius for another period of time when the diamond film continues to grow.

As discussed above, the temperature of the work pieces 4 does not exceed 1000 degrees Celsius. With the special pre-processing and the plasma-enhanced deposition, the structure of the resultant diamond is similar to that of natural diamond. The tribology and adhesion are increased so that the usage and industrial applicability of the diamond film are increased. The stress of the diamond film is reduced. The friction on the work pieces 4 is reduced. Therefore, the work pieces 4 can be used to process printed circuit boards at high rotational speeds without the risk of breach. The life of a tungsten carbide router coated with diamond of 5 to 8 micrometers is more than 6 times as long as that of a tungsten carbide router without diamond film coating.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for hot filament chemical vapor deposition for coating diamond on work pieces comprising:
a chamber, wherein the chamber is water-cooled and the pressure is controllable therein;
a valve provided on the chamber;
a pump in communication with the valve for pumping air from the chamber;
a pressure gauge inserted in the chamber;
a pressure regulator connected to the valve on one side and connected to the pressure gauge on the other side for controlling the valve based on the reading of the pressure gauge;
a grid comprising vents defined therein, wherein the grid is mechanically disposed in but electrically isolated from the chamber;
a grid-bias power supply for supplying a bias to the grid for generating plasma;
a holder comprising rows of vents defined therein and rows of apertures defined therein for holding the work pieces, wherein the rows of vents and the rows of apertures are arranged alternately, and the holder is disposed in but isolated from the chamber;
a holder-bias power supply for supplying a bias to the holder for generating the plasma;
stationary holding elements mechanically disposed in but electrically isolated from the chamber;
movable holding elements disposed in the chamber;
filaments arranged in two tiers between the grid and the holder, wherein each of the tiers includes rows, and each row of each tier of the filaments is supported by and between a related stationary holding element and a related movable holding element;
tension controllers each comprising an end mechanically connected to but electrically isolated from a related movable holding element and another end connected to the chamber so that each tension controller is operable to horizontally move the related row of each tier of the filaments;
a filament power supply for energizing the filaments to heat up;
a programmable temperature controller for controlling the filament power supply to make the filaments work at different temperatures in different periods; and
a pipe extending in the chamber and comprising tapering vents for spraying reaction gas upwards so that the reaction gas uniformly falls and is finally pumped out of the chamber by the pump.

2. The apparatus according to claim 1 wherein the reaction gas includes at least one ingredient selected from a group consisting of hydrogen, acetylene, ethane, benzene and alcohol.

3. The apparatus according to claim 1, wherein the pipe includes a shape selected from a group consisting of T-shaped, cruciform and multi-directional.

4. The apparatus according to claim 1, wherein the filament is made of at least one material selected from a group consisting of tungsten, molybdenum, tantalum and high melt-point metal or alloy.

5. The apparatus according to claim 1 comprising:
posts each comprising an end secured to the chamber and another end for supporting a related stationary holding element; and isolating caps, there in each is provided between a related post and a related stationary holding element.

6. The apparatus according to claim 1 comprising:
mounts secured to the chamber for supporting the stationary holding elements; and
isolating pins each comprising an end attached to a related mount and another end inserted in a related stationary holding element.

7. The apparatus according to claim 1, wherein the distance between two adjacent ones of the filaments is 1 to 2 cm, and the distance between the filaments and the grid is 0.5 to 2 cm, and the distance between the filaments and the work pieces is 0.3 to 1 cm.

8. The apparatus according to claim 1, wherein the diameter of the vents of the grid and the holder is 0.3 to 5 mm, and the vents are closer to one another near the center of the grid than near the periphery of the grid.

9. The apparatus according to claim 1, wherein the holder is made of metal plate with many vent holes.

10. The apparatus according to claim 1, wherein based on the height of the work pieces, the height of the holder can be changed by using isolating sleeves of different height.

11. The apparatus according to claim 1, where in the thermometer is inserted in the chamber.

12. The apparatus according to claim 1, wherein the thermometer is an infrared thermometer provided on an external side of the chamber.

13. The apparatus according to claim 1, wherein the distance between any two adjacent rows of apertures of the holder is equal to the distance the distance between any two adjacent rows of filaments, and the diameter of the apertures of the carrier is 1 to 20 mm.

14. The apparatus according to claim 1, wherein the biases are direct currents or direct current pulses.

15. The apparatus according to claim 1, wherein the programmable temperature controller is selected from a group consisting of a programmable logic controller and a computer that provide multi-point detection of temperature and control over temperature differentials.

16. A method for hot-filament deposition for coating diamond on work pieces comprising the steps of:
submerging the work pieces in first chemical solution for roughening the work pieces and removing cobalt;
introducing diamond grains into the first chemical solution;
subjecting the first chemical solution to ultrasonic oscillation;
disposing the work pieces in a hot-filament deposition apparatus;
introducing a first methane/hydrogen mixture into the apparatus;
providing a filament power supply to energize filaments to heat the work pieces;
providing a positive bias to grid and a negative bias to the holder while removing impurity from the work pieces;
introducing a second methane/hydrogen mixture into the apparatus, wherein plasma is generated because of discharge between the grid and the filaments to aid nucleation of diamond on the work pieces before biases are stopped;
cooling the apparatus in a stable gradient to cause chemical re-composition to grow diamond on the work pieces before stopping the supply of the second
methane/hydrogen mixture; and
cooling the apparatus so that the work pieces can be removed.

17. The method according to claim 16, wherein the first chemical solution comprises potassium ferricyanide, potassium hydroxide and de-ionized water.

18. The method according to claim 16, wherein the diameter of the diamond grains is smaller than 1 micrometer.

19. The method according to claim 16, wherein the concentration of the first methane/hydrogen mixture is 0.5% to 4%, the positive bias is 30 to 200 volts, and the negative bias is −30 to −150 volts, the nucleation is conducted at 900 to 980 degrees Celsius, at 1 to 30 torrs for 3 minutes to 3 hours.

20. The method according to claim 16, wherein the concentration of the second methane/hydrogen mixture is 0.5% to 4%, the grid is grounded, the work pieces are grounded or floating, the temperature is reduced to and retained at 780 degrees Celsius and the pressure is retained at 10 to 50 torrs during the growth of the diamond on the work pieces that lasts for 5 to 20 hours.
